(19) United States
(12) Patent Application Publication
(10) Pub. No.: US 2014/0344105 A1
(43) Pub. Date: Nov. 20, 2014

(54) Systems and Methods for Managing Layaway Payments

(71) Applicant: Sears Brands, LLC, Hoffman Estates, IL (US)

(72) Inventor: Linda Liu, Streamwood, IL (US)

(21) Appl. No.: 13/896,841

(22) Filed: May 17, 2013

(51) Int. Cl. G06Q 30/06

(52) U.S. Cl. CPC G06Q 30/0633
USPC 705/26.8

(57) ABSTRACT

A method for managing layaway payments in connection with an online retail channel of a retailer may include establishing a layaway contract for an item available for sale by the retailer. The layaway contract may be associated with a purchaser of the item, and may include a payment obligation by the purchaser to pay an initial layaway payment and one or more remaining layaway payments for the item. The establishing may include receiving at least the initial payment for the item. Upon receiving a request for making a payment on the layaway contract, at least one of the remaining layaway payments for the item may be added to an electronic commerce (e-commerce) shopping cart. The e-commerce shopping cart may be associated with purchases made via the online retail channel of the retailer. The establishing may include receiving billing information and payment information of the purchaser.

### FIELD OF THE DISCLOSURE

The subject disclosure relates generally to retail systems and, more particularly, relates to systems and methods for managing layaway payments.

### BACKGROUND

Many conventional “brick and mortar” stores utilize layaway services, where a buyer reserves an article of merchandise by placing a deposit with the retailer and then making periodic payments until the balance is paid in full. Even though layaway services are gaining popularity among the conventional “brick and mortar” stores, the online layaway services offered by many retailers lack flexibility, especially with regard to making and managing the periodic layaway payments.

Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

A system and/or method is provided for managing layaway payments, substantially as shown in and/or described in connection with at least one of the figures, as set forth more completely in the claims.

These and other advantages, aspects and features of the present disclosure, as well as details of illustrated implementation(s) thereof, will be more fully understood from the following description and drawings.

### BRIEF DESCRIPTION OF THE DRAWINGS

FIG. 1 is a block diagram illustrating example retail, computer network environment for managing layaway payments, in accordance with an example embodiment of the disclosure.

FIG. 2 is a block diagram illustrating a screen shot of graphical user interfaces, which may be used for managing layaway payments, in accordance with an example embodiment of the disclosure.

FIG. 3 is a flow chart illustrating example steps of a method for managing layaway payments, in accordance with an example embodiment of the disclosure.

FIG. 4 is a flow chart illustrating example steps of another method for managing layaway payments, in accordance with an example embodiment of the disclosure.

FIG. 5 is a flow chart illustrating example steps of yet another method for managing layaway payments, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations. As utilized herein, the term “processor” may be used to refer to one or more of a central processing unit, a processor of a symmetric or asymmetric multiprocessor system, a digital signal processor, a micro-controller, a graphics/video processor, or another type of processor.

The present disclosure relates to a method and system for managing layaway payments. In various implementations, customers of a retailer with conventional (“brick and mortar”) stores and an online store, may be allowed to treat interim layaway payments (e.g., for an item with already established layaway plan) as an individual item, which can be placed in an online shopping cart associated with the online store of the retailer. Additionally, the customer may be allowed to place additional items from the online store into the shopping cart, and upon checkout, pay for all items in the shopping cart, including the interim layaway payment.

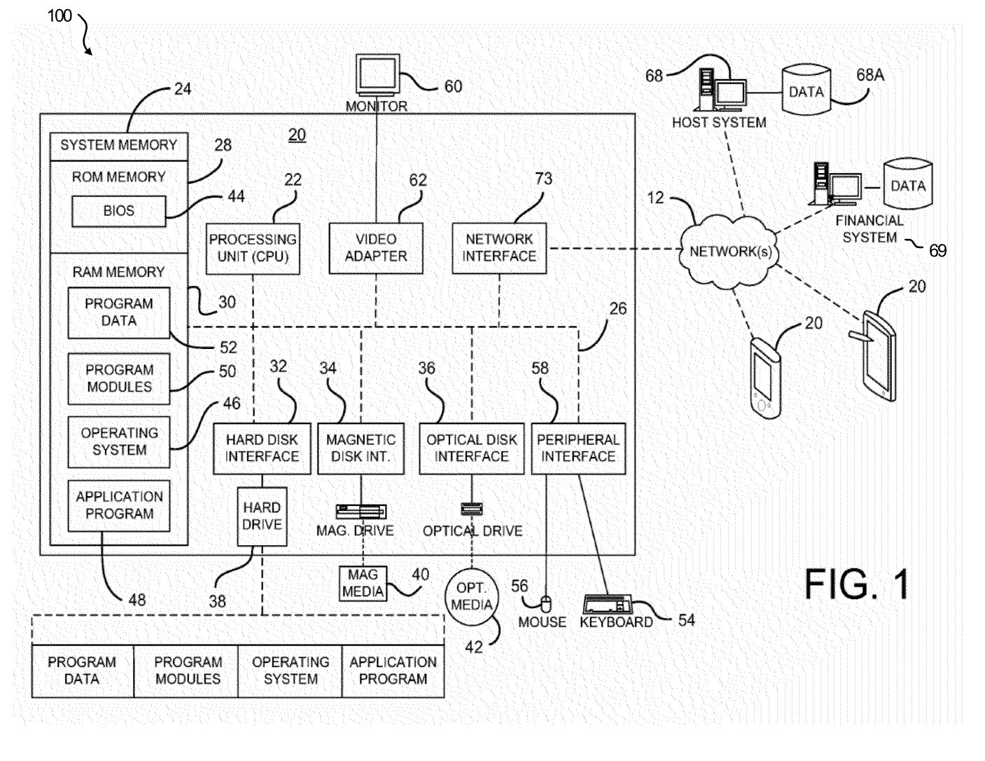

FIG. 1 is a block diagram illustrating example retail, computer network environment for managing layaway payments, in accordance with an example embodiment of the disclosure. Referring to FIG. 1, the retail, computer network environment 100 may comprise a processing device 20 and a vendor system server (or a host) 68, which may be associated with a retailer. The processing device 20 may comprise a computing device such as a smart phone, a mobile phone, a tablet and/or other mobile or computing devices. The host 68 may comprise suitable circuitry, logic and/or code and may be implemented as one or more network servers, which may be operable to implement an online retail channel of a retailer (e.g., one or more online stores of the retailer, where customers may shop for items sold by the retailer and/or order/pay for other services in connection with items sold by the retailer, such as establish a layaway contract for one or more items and/or make one or more payments on an established layaway contract).

The processing device 20, illustrated in the exemplary form of a computer system, is provided with executable instructions to, for example, provide a means (e.g., one or more user interfaces in a web page) for a consumer, e.g., a user, customer, etc., to access the vendor system server 68 and, among other things, to browse through an online catalog of items available for sale in the online retail channel of the retailer; order one or more of such items by placing them in an online e-commerce shopping cart available for use at the online store; establish a layaway contract for an item available for sale at the online store (or at a conventional “brick and mortar” store) of the retailer by making an initial layaway payment; making one or more intermediate layaway payments on an established layaway contract by placing such payment(s) in the online e-commerce shopping cart; pay for items in the online shopping cart, including one or more intermediate (or a final) layaway payment(s) associated with an established layaway contract; and set up delivery of paid items such as items with paid-in-full layaway contract and/or items paid during an online checkout at the online retail channel (Internet web store) of the retailer.

Generally, the computer executable instructions may reside in program modules, which may include routines, programs, objects, components, data structures, etc. that perform particular tasks or implement particular abstract data types. Accordingly, those of ordinary skill in the art will appreciate that the processing device 20 illustrated in FIG. 1 may be embodied in any device having the ability to execute instructions, such as, by way of example, a personal computer, mainframe computer, personal-digital assistant (“PDA”), cellular telephone, or the like. Furthermore, while described and illustrated in the context of a single processing device 20, those of ordinary skill in the art will also appreciate that the various tasks described hereinafter may be practiced in a distributed environment having multiple processing devices linked via a wired and/or wireless local (LAN) or wide-area network (WAN), whereby the executable instructions may be associated with and/or executed by one or more of multiple processing devices.

For performing the various tasks in accordance with the executable instructions, the processing device 20 preferably includes a processing unit 22 and a system memory 24, which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those of ordinary skill in the art will further appreciate that other types of non-transitory computer readable media that can store data and/or instructions may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories and memory devices.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more application programs 48 (such as a Web browser), other program modules 50, and/or program data 52. Still further, computer-executable instructions may be downloaded to one or more of the computing devices as needed, for example via a network connection.

To allow a user to enter commands and information into the processing device 20, input devices such as a keyboard 54 and/or a pointing device 56 may be provided. While not illustrated, other input devices may include a microphone, a joystick, a game pad, a scanner, a camera, etc. These and other input devices may be connected to the processing unit 22 by means of an interface 58 which, in tum, may be coupled to the bus 26. Input devices may be connected to the processor 22 using interfaces such as, for example, a parallel port, game port, FireWire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and/or printers.

As noted, the processing device 20 may also utilize logical connections to one or more remote processing devices, such as the vendor system server 68 having associated data repository 68A. In this regard, while the vendor system server 68 has been illustrated in the exemplary form of a computer, it will be appreciated that the vendor system server 68 may, like processing device 20, be any type of a computing device having processing capabilities. Again, it will be appreciated that the vendor system server 68 need not be implemented as a single device but may be implemented in a manner, such that the tasks performed by the vendor system server 68 are distributed amongst a plurality of processing devices/databases located at different geographical locations and linked through a wired and/or wireless communication network. Additionally, the vendor system server 68 may have logical connections to other third party systems (e.g., 69) via the network 12 and, via such connections, will be associated with data repositories that are associated with such other third party systems. Such third party systems 69 may include, without limitation, systems of banking, credit, or other financial institutions, systems of third party providers of goods and/or services, systems of shipping/delivery companies, etc.

For performing tasks as needed, the vendor system server 68 may include many or all of the elements described above relative to the processing device 20, for example. In addition, the vendor system server 68 may include executable instructions for, among other things, browsing through an online catalog of items available for sale in the online retail channel of the retailer; ordering one or more of such items by placing them in an online e-commerce shopping cart available for use at the online store; establishing a layaway contract for an item available for sale at the online store (or at a conventional “brick and mortar” store) of the retailer by making an initial layaway payment; making one or more intermediate layaway payments on an established layaway contract by placing such payment(s) in the online e-commerce shopping cart; paying for items in the online shopping cart, including one or more intermediate (or a final) layaway payment(s) associated with an established layaway contract; and setting up delivery of paid items such as items with paid-in-full layaway contract and/or items paid during an online checkout at the online retail channel (Internet web store) of the retailer.

Communications between the processing device 20 and the vendor system server 68 may be exchanged via a further processing device, such as a network router 72, which may be responsible for network routing. Communications with the network router 72 may be performed via a network interface component 73. Thus, within such a networked environment, e.g., the Internet, World Wide Web, LAN, or other similar type of wired and/or wireless network, it will be appreciated that program modules depicted relative to the processing device 20, or portions thereof, may be stored in the non-transitory memory storage device(s) of the vendor system server 68.

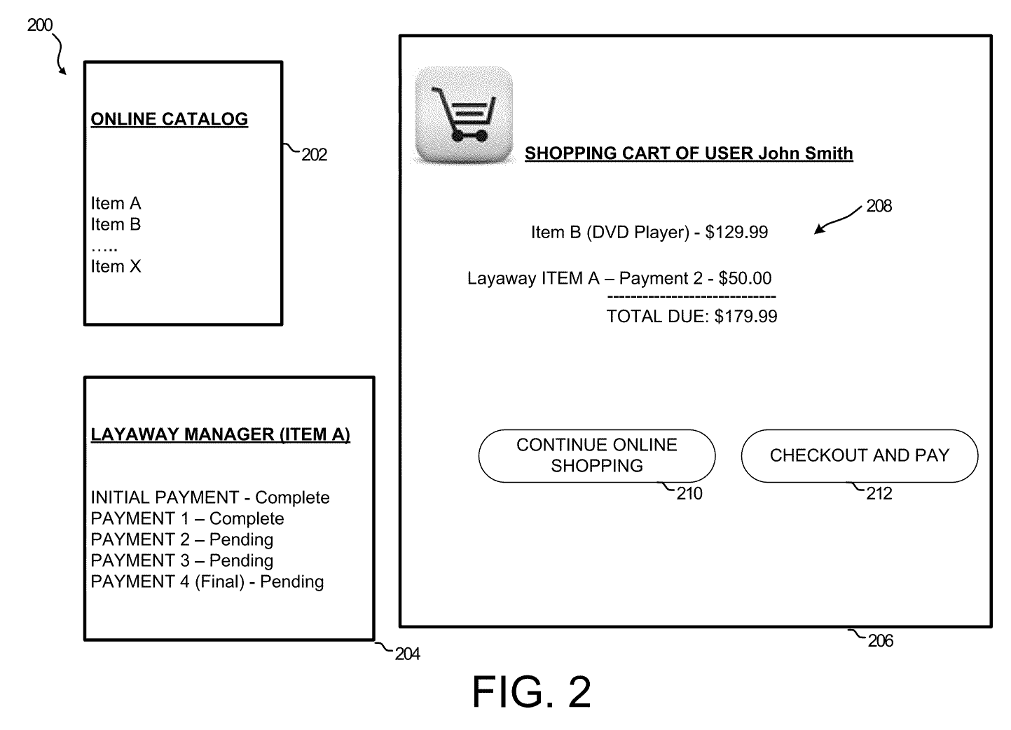

FIG. 2 is a block diagram illustrating a screen shot of graphical user interfaces, which may be used for managing layaway payments, in accordance with an example embodiment of the disclosure. Referring to FIG. 2, the screen shot 200 may illustrate an example graphic user interface (GUI), which may be displayed at the monitor 60 during an example online browsing/checkout session associated with an online retail channel of a retailer and maintained by, for example, the vendor system server 68.

For example, during an example online browsing session using device 20, a customer may browse through an online catalog 202 of items (e.g., items A, . . . , X) available for sale at the online retail channel (e.g., as implemented by the vendor system server 68). The customer may decide to place item A on a layaway contract and, consequently, may cause the layaway manager 204 to be displayed on the monitor 60. Additionally, the customer may select Item B for purchase by placing Item B in the e-commerce online shopping cart 206.

The layaway manager 204 may provide the customer with functionalities for managing the layaway contract (e.g., setting up the total number of layaway payments, the amount of each payment, the duration of the layaway contract, entering customer identifying information, entering payment information, and/or payment of the initial layaway payment). An example layaway contract may be considered “established” if the layaway item has been identified and the initial layaway payment has been received.

In this regard, the layaway manager 204 may also be executed and displayed on monitor 60 in connection with an already established layaway contract (e.g., the item has been identified and at least the initial layaway payment has been received), as illustrated in FIG. 2. More specifically, the layaway manager 204 in FIG. 2 illustrates a GUI identifying the layaway item as Item A from the online catalog 202, the layaway contract is for a total of 5 payments, and the initial layaway payment and layaway payment 1 have all been received from the customer.

In accordance with an example embodiment of the disclosure, the layaway manager 204 may enable the customer to add a subsequent layaway payment (e.g., layaway payment 2) to the shopping cart 206. More specifically, one or more of the remaining layaway payments (e.g., payments 1, . . . , 4) for an established layaway contract may be placed as separate items in the shopping cart 206.

As seen in FIG. 2, the shopping cart 206 may provide a summary 208 of the items placed in the shopping cart with the total amount due. The shopping cart 206 may also provide GUIs (e.g., on-screen “buttons”) 210 and 212. GUI 210 may be used by the customer to continue browsing through (and shopping) the online catalog 202 (e.g., a new layaway contract for another item may be initiated by placing the initial payment in the shopping cart 206). If the customer has completed shopping, GUI 212 may be activated, triggering a new GUI (not illustrated) where checkout and payment for all items in the shopping cart 206 (including one or more of the interim layaway payments) may be completed. If any of the layaway contracts are paid in full, the customer may set up delivery of the paid-in-full items (or pick up from a store location of the retailer).

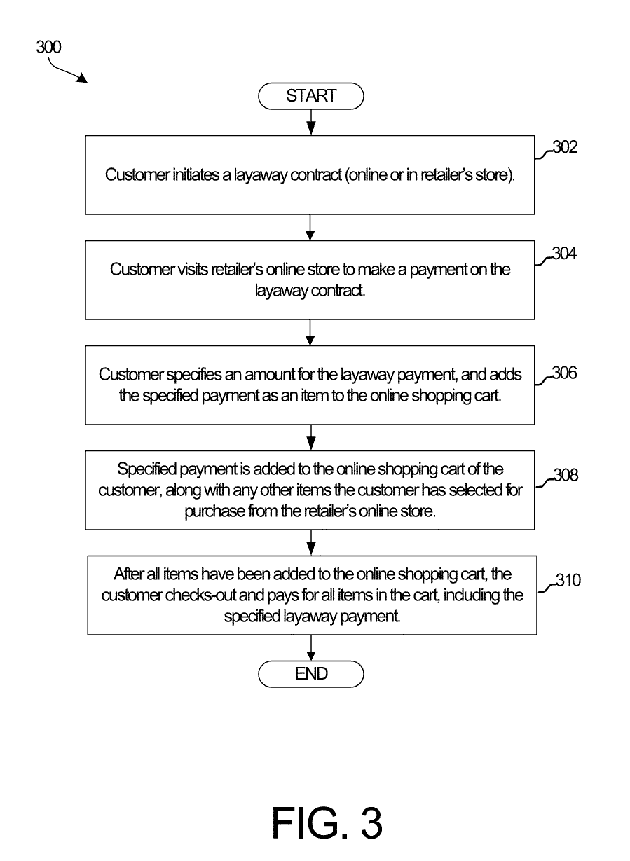

FIG. 3 is a flow chart illustrating example steps of a method for managing layaway payments, in accordance with an example embodiment of the disclosure. Referring to FIGS. 1-3, the example method 300 may start at 302, when a customer may initiate a layaway contract (e.g., online or in retailer's store). For example, a customer may initiate a layaway contract for item A listed in the online catalog 202 by making an initial layaway payment (e.g., via the shopping cart 206 or in person at a store location of the retailer).

At 304, the customer may visits retailer's online store to make a payment on the layaway contract. For example, the customer may activate the layaway manager 204 and, at 306, may specify an amount for an interim layaway payment (e.g., an amount of $50 may be specified for layaway payment 2). The specified layaway payment 2 may be added as an item to the online shopping cart 206. At 308, the specified payment (e.g., layaway payment 2) may be added to the online shopping cart 206 of the customer, along with any other items the customer has selected for purchase from the retailer's online store (e.g., item B from the online catalog 202). At 310, after all items have been added to the online shopping cart 206, the customer may check-out (e.g., by activating GUI 212) and pay for all items in the cart 206, including the specified layaway payment (e.g., layaway payment 2).

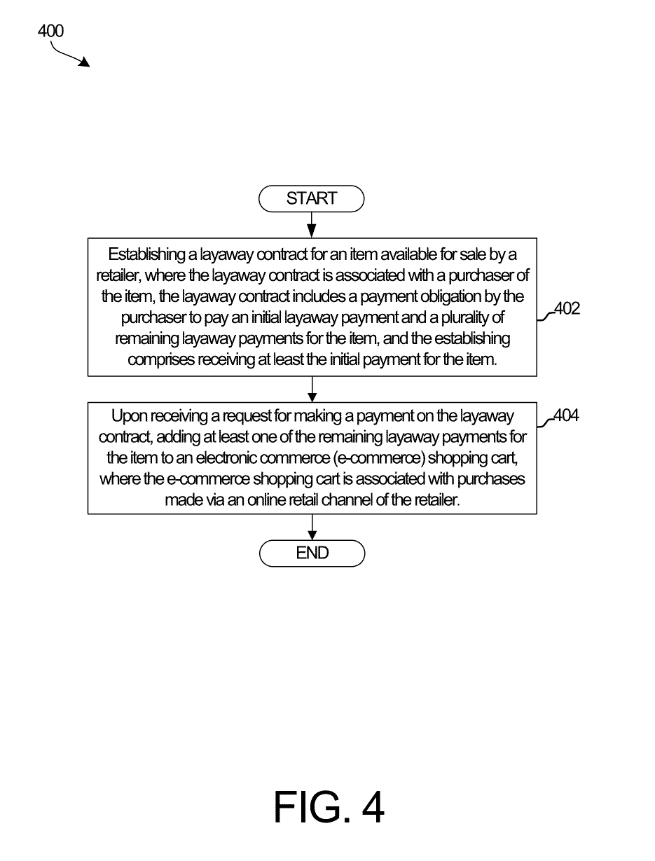

FIG. 4 is a flow chart illustrating example steps of another method for managing layaway payments, in accordance with an example embodiment of the disclosure. Referring to FIGS. 1-2 and 4, the example method 400 may start at 402 when a layaway contract may be established for an item (e.g., item A) available for sale by a retailer. The layaway contract may be associated with a purchaser of the item and may include a payment obligation by the purchaser to pay an initial layaway payment and a plurality of remaining layaway payments for the item. The establishing of the layaway contract may include receiving at least the initial payment for the item (e.g., as seen in the layaway manager 204 in FIG. 2).

At 404, upon receiving a request for making a payment on the layaway contract, at least one of the remaining layaway payments for the item (e.g., layaway payment 2 for item A) may be added to an electronic commerce (e-commerce) shopping cart (e.g., 206). The e-commerce shopping cart 206 may be associated with purchases made via an online retail channel of the retailer.

The establishing of the layaway contract may include receiving billing information and payment information of the purchaser. The layaway contract may include a schedule of the payment obligation specifying one or more of a number of the plurality of remaining layaway payments, an amount of the plurality of remaining layaway payments, and/or a duration of the layaway contract. The layaway contract may be established at a store location of the retailer or an online web page associated with the online retail channel of the retailer (e.g., via the layaway manager 204 and the shopping cart 206).

Upon adding the one or more of the remaining layaway payments (e.g., layaway payment 2) to the e-commerce shopping cart 206, the purchaser may be presented with at least one user interface (e.g., 210 and 212). The at least one user interface may enable displaying to the purchaser, an online catalog of additional items offered for sale by the online retail channel of the retailer (e.g., by activating GUI 210), and adding at least one of the additional items (e.g., item X) to the e-commerce shopping cart associated with the purchaser. Upon receiving a selection of at least one of the additional items (e.g., item X), the at least one of the additional items may be added to the e-commerce shopping cart 206 (not illustrated in FIG. 2). Activating GUI 212 may cause a checkout review page to be presented to the purchaser. The checkout review page may be used by the purchaser to generate an order via the online retail channel of the retailer, and to pay for the at least one of the remaining layaway payments in the e-commerce shopping cart 206. Prior to adding the at least one of the remaining layaway payments, an input may be received, which may specify an amount for the at least one of the remaining layaway payments for the item.

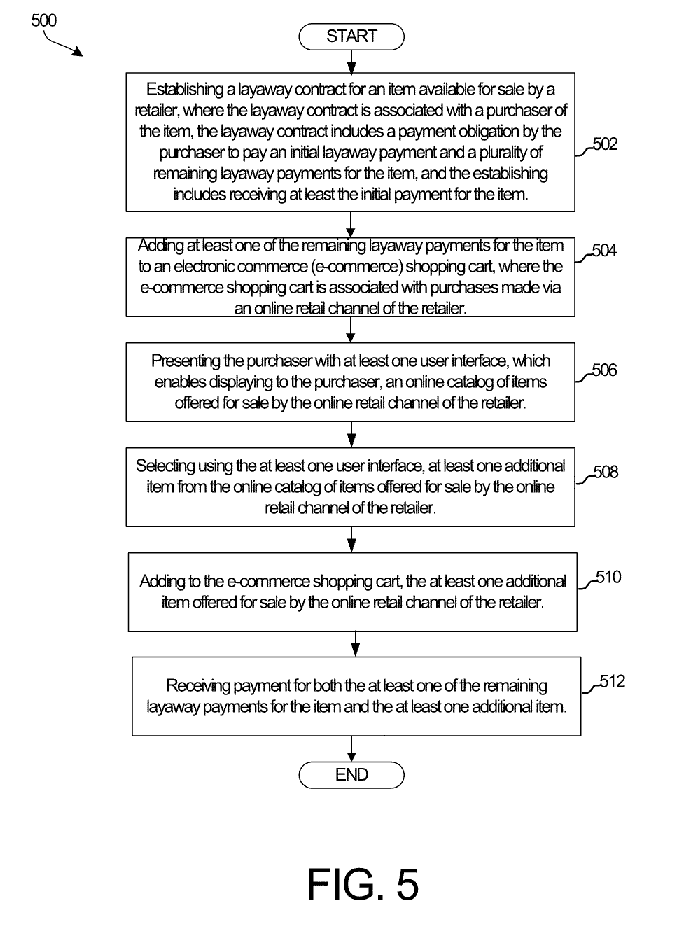

FIG. 5 is a flow chart illustrating example steps of yet another method for managing layaway payments, in accordance with an example embodiment of the disclosure. Referring to FIGS. 1-2 and 5, the example method 500 may start at 502, when a layaway contract may be established for an item (e.g., item A) available for sale by a retailer. The layaway contract may be associated with a purchaser of the item, and may include a payment obligation by the purchaser to pay an initial layaway payment and a plurality of remaining layaway payments (e.g., payments 1-4) for the item. The establishing of the contract may include receiving at least the initial layaway payment for the item.

At 504, at least one of the remaining layaway payments for the item (e.g., payment 2) may be added to an electronic commerce (e-commerce) shopping cart (e.g., 206). The e-commerce shopping cart 206 may be associated with purchases made via an online retail channel of the retailer. At 506, the purchaser may be presented with at least one user interface, which enables displaying to the purchaser, an online catalog of items offered for sale by the online retail channel of the retailer (e.g., online catalog 202). At 508, at least one additional item (e.g., item B) from the online catalog (e.g., 202) of items offered for sale by the online retail channel of the retailer, may be selected using the at least one user interface. At 510, the at least one additional item (e.g., item B) offered for sale by the online retail channel of the retailer, may be added to the e-commerce shopping cart 206. At 512, payment for both the at least one of the remaining layaway payments for the item (e.g., payment 2) and the at least one additional item (e.g., item B) may be received (e.g., by activating the GUI 212).

Other implementations may provide a machine-readable storage device, having stored thereon, a machine code and/or a computer program having at least one code section executable by a machine and/or a computer, thereby causing the machine and/or computer to perform the steps as described herein for managing layaway payments.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method for managing layaway payments in connection with an online retail channel of a retailer, comprising:
establishing a layaway contract for an item available for sale by the retailer, wherein:
the layaway contract is associated with a purchaser of the item;
the layaway contract comprises a payment obligation by the purchaser to pay an initial layaway payment and one or more remaining layaway payments for the item; and
the establishing comprises receiving at least the initial payment for the item; and
upon receiving a request for making a payment on the layaway contract, adding at least one of the remaining layaway payments for the item to an electronic commerce (e-commerce) shopping cart, wherein the e-commerce shopping cart is associated with purchases made via the online retail channel of the retailer.

2. The method according to claim 1, wherein the establishing comprises:
receiving billing information and payment information of the purchaser.

3. The method according to claim 1, wherein the layaway contract comprises a schedule of the payment obligation specifying a number of the one or more remaining layaway payments, an amount of the plurality of remaining layaway payments, and a duration of the layaway contract.

4. The method according to claim 1, comprising:
establishing the layaway contract at one of a store location of the retailer and an online web page associated with the online retail channel.

5. The method according to claim 1, comprising:
upon adding the at least one of the remaining layaway payments to the e-commerce shopping cart, presenting the purchaser with at least one user interface, wherein the at least one user interface enables:
displaying to the purchaser, an online catalog of additional items offered for sale by the online retail channel of the retailer; and
adding at least one of the additional items to the e-commerce shopping cart associated with the purchaser.

6. The method according to claim 5, comprising:
upon receiving a selection of at least one of the additional items, adding the at least one of the additional items to the e-commerce shopping cart.

7. The method according to claim 1, comprising:
causing a checkout review page to be presented to the purchaser, wherein the checkout review page is used by the purchaser to generate an order via the online retail channel of the retailer and to pay for the at least one of the remaining layaway payments in the e-commerce shopping cart.

8. The method according to claim 1, comprising:
receiving an input prior to the adding, the input specifying an amount for the at least one of the remaining layaway payments for the item.

9. A non-transitory, machine-readable storage medium, having stored thereon a computer program having at least one code section for managing layaway payments in connection with an online retail channel of a retailer, the at least one code section executable by a machine for causing the machine to perform a method comprising:
establishing a layaway contract for an item available for sale by the retailer, wherein:
the layaway contract is associated with a purchaser of the item;
the layaway contract comprises a payment obligation by the purchaser to pay an initial layaway payment and one or more remaining layaway payments for the item; and
the establishing comprises receiving at least the initial payment for the item; and
upon receiving a request for making a payment on the layaway contract, adding at least one of the remaining layaway payments for the item to an electronic commerce (e-commerce) shopping cart, wherein the e-commerce shopping cart is associated with purchases made via the online retail channel of the retailer.

10. The non-transitory, machine-readable storage medium according to claim 9, wherein the establishing comprises code for:
receiving billing information and payment information of the purchaser.

11. The non-transitory, machine-readable storage medium according to claim 9, wherein the layaway contract comprises a schedule of the payment obligation specifying a number of the one or more remaining layaway payments, an amount of the plurality of remaining layaway payments, and a duration of the layaway contract.

12. The non-transitory, machine-readable storage medium according to claim 9, wherein the at least one code section comprises code for:
establishing the layaway contract at one of a store location of the retailer and an online web page associated with the online retail channel.

13. The non-transitory, machine-readable storage medium according to claim 9, wherein the at least one code section comprises code for:
upon adding the at least one of the remaining layaway payments to the e-commerce shopping cart, presenting the purchaser with at least one user interface, wherein the at least one user interface enables:
displaying to the purchaser, an online catalog of additional items offered for sale by the online retail channel of the retailer; and
adding at least one of the additional items to the e-commerce shopping cart associated with the purchaser.

14. The non-transitory, machine-readable storage medium according to claim 13, wherein the at least one code section comprises code for:
upon receiving a selection of at least one of the additional items, adding the at least one of the additional items to the e-commerce shopping cart.

15. The non-transitory, machine-readable storage medium according to claim 9, wherein the at least one code section comprises code for:
causing a checkout review page to be presented to the purchaser, wherein the checkout review page is used by the purchaser to generate an order via the online retail channel of the retailer and to pay for the at least one of the remaining layaway payments in the e-commerce shopping cart.

16. The non-transitory, machine-readable storage medium according to claim 9, wherein the at least one code section comprises code for:
receiving an input prior to the adding, the input specifying an amount for the at least one of the remaining layaway payments for the item.

17. A method for managing layaway payments in connection with an online retail channel of a retailer, comprising:
establishing a layaway contract for an item available for sale by the retailer, wherein:
the layaway contract is associated with a purchaser of the item;
the layaway contract comprises a payment obligation by the purchaser to pay an initial layaway payment and one or more remaining layaway payments for the item; and
the establishing comprises receiving at least the initial payment for the item;
adding at least one of the remaining layaway payments for the item to an electronic commerce (e-commerce) shopping cart, wherein the e-commerce shopping cart is associated with purchases made via the online retail channel of the retailer;
adding to the e-commerce shopping cart, at least one additional item offered for sale by the online retail channel of the retailer; and
receiving payment for both the at least one of the remaining layaway payments for the item and the at least one additional item.

18. The method according to claim 1, comprising:
upon adding the at least one of the remaining layaway payments to the e-commerce shopping cart, presenting the purchaser with at least one user interface, wherein the at least one user interface enables displaying to the purchaser, an online catalog of items offered for sale by the online retail channel of the retailer.

19. The method according to claim 18, comprising:
selecting using the at least one user interface, the at least one additional item from the online catalog of items offered for sale by the online retail channel of the retailer.

20. The method according to claim 17, comprising:
if the at least one of the remaining layaway payments is a last remaining layaway payment, causing one of a merchandise shipment confirmation or a merchandise pickup confirmation to be presented to the purchaser, wherein:
the merchandise shipment confirmation indicates a shipping address and shipping date of the item; and/or
the merchandise pickup confirmation indicates a store location the item will be available for pickup by the purchaser.
